(19) United States
(12) Patent Application Publication
(10) Pub. No.: US 2013/0062833 A1
(43) Pub. Date: Mar. 14, 2013

(54) DEVICE FOR FIXING ELASTIC ELEMENTS

(71) Applicants: Hubertus Frank, Hochstadt (DE); Henrik Albertsen, Nurnberg (DE)

(72) Inventors: Hubertus Frank, Hochstadt (DE); Henrik Albertsen, Nurnberg (DE)

(21) Appl. No.: 13/261,362

(22) PCT Filed: Jan. 11, 2011
(86) PCT No.: PCT/EP11/00064

§ 371 Date: Nov. 19, 2012

(30) Foreign Application Priority Data
Jan. 14, 2010 (DE) 10 2010 004 780.5
Mar. 31, 2010 (DE) 10 2010 013 742.1

(51) Int. Cl. F16J 15/16

(52) U.S. Cl. CPC F16J 15/16
USPC 277/345

(57) ABSTRACT

The invention relates to a device for sealing a gap between parts that are moved relative to one another, namely a fixing part, for fixing at least one elastic sealing element at an edge thereof, and a stop part along which another edge of at least one elastic sealing element runs, wherein the fixing part comprises, running along the gap, at least one groove in which are inserted one or more anchoring parts that engage through or around the sealing element and/or a retaining element that retains same.

### BACKGROUND OF THE INVENTION

1. Field of the Invention

The invention relates to a device for sealing a gap between parts that are moved relative to one another, namely a fixing part to which at least one elastic sealing element is fixed by one of its edges, and a stop part along which another edge of at least one elastic sealing element runs.

2. Description of the Prior Art

Gaps between parts that are moved relative to one another are usually sealed by means of linear or annular elastic sealing elements, preferably having a substantially flat cross section, i.e., a ribbon-shaped structure bounded by two longitudinal edges. To fix them in place, the sealing elements are inserted by a preferably broadened longitudinal edge in a groove extending parallel to the gap and provided in one of the two parts to be sealed, referred to hereinafter as the fixing part, and are thereby fixed, while their opposite longitudinal edge grazes along the respective other one of the two parts, referred to hereinafter as the stop part, and thereby seals the gap.

The gap to be sealed between two parts that are moved relative to each other is often filled with a lubricant, particularly grease, which is to be held in place by the elastic sealing element. A sealing element inserted in a groove is usually also able to perform this function. Under some circumstances, the lubricant can also be pressurized to enhance the lubricating effect. But sealing elements that are anchored as described, by being inserted in a groove, can rarely stand up to the resulting pressure differential; they are almost always lifted out of their anchoring groove until they yield and allow lubricant to escape, resulting in a pressure drop.

### SUMMARY OF THE INVENTION

From the disadvantages of the described prior art comes the problem initiating the invention, to design a device for fixing elastic elements such that the elements can withstand a pressure differential even on the order of one or more bars without leaking. In addition, the technical expenditure for such an anchoring system should be as low as possible.

The solution to this problem is achieved by the fact that in a seal of the generic kind, the fixing part comprises, running along the gap, a groove in which are inserted one, or preferably more, anchoring parts that engage through or around the sealing element and/or a retaining element that retains same.

With an arrangement of this kind, the invention achieves the actually competing goals of particularly firm anchoring, on the one hand, and the lowest possible technical expenditure, on the other. A groove is provided in the fixing part, as before, but there is no need either to bore individual anchoring holes or to cut thread. The anchoring elements can be prefabricated in a standardized manner and secure the elastic sealing element form-lockingly.

It has proven advantageous for the extent of a portion of an anchoring part that engages in the groove to be, in the longitudinal direction of the groove, equal to or less than twice the maximum width of the groove, preferably equal to or less than one and a half times the maximum width of the groove, thus, in particular, making it possible to minimize the weight of such an anchoring part.

Such anchoring parts preferably are not packed tightly together but are spaced apart, for example, by a distance that is greater than their extent in the direction of the groove, preferably twice or more as great as their extent in the direction of the groove, and in particular at least three or four or even five times or more as great.

It has proven beneficial for the extent of the core of a portion of an anchoring part that engages in the groove to correspond, in the longitudinal direction of the groove, to approximately the width of the groove. “Core” here signifies in particular a mathematical body, for example a cylinder, that is inscribed in a surface structure such as, for example, a thread, i.e., the anchoring body “minus” the surface structure. In the case of a screw thread, therefore, the size corresponds to the core diameter of the thread.

The invention further provides that an anchoring part is configured as a threaded bolt or a screw, preferably as a machine screw, particularly as a machine screw with a self-tapping thread. Such a machine screw can be screwed into the anchoring groove, according to the invention, transversely to the longitudinal direction of the groove, in which case the screw thread automatically cuts the necessary internal thread segments into the flanks of the groove. The then mating thread segments ensure reliable anchoring of the screw in the groove.

An alternative embodiment to the foregoing is characterized by the fact that an anchoring part is configured as a rivet, particularly a blind rivet, whose inner head is disposed in an undercut region of the groove, that is, a region that is broadened in relation to the groove aperture. The inner rivet head thus provides form-locking anchoring of the rivet in the anchoring groove, while the upper or outer rivet head also form-lockingly overlaps the elastic sealing element, or a fixing element that retains the latter.

An anchoring part can also be configured as a sleeve which is pushed onto, or can be slid onto, a core. In this case, the core stabilizes the sleeve and/or deforms it on being inserted in a suitable manner to achieve stable anchoring.

The invention can be developed further by having the core broaden to the bottom of the groove, so as to expand a pushed-on sleeve in the region of the bottom of the groove and thereby anchor the sleeve.

It is within the scope of the invention that a portion of an anchoring part provided for engagement in the groove has a rotationally symmetrical cross section, apart from any thread disposed thereon. Such a structure facilitates the insertion of the anchoring part, since the latter need not be aligned parallel to the longitudinal direction of the groove before being inserted.

In one particular embodiment, a portion of an anchoring part for engagement in the groove has an elongated cross section that allows it to be inserted when rotated in the longitudinal direction of the groove and to be anchored against an undercut of the groove when rotated transversely to the longitudinal direction of the groove. Even though anchoring takes place via a rotating movement, the resulting anchoring is still reliable and features very high retention force.

An elastic sealing element can be firmly clamped to a surface of the fixing part. This means, for example, that a region of the surface of the sealing element rests flat against the surface of the fixing part and is pressed thereagainst by the anchoring parts to create a friction lock, thus fixing it in place.

Alternatively, it is also possible for an elastic sealing element to be firmly clamped in a fillet of the fixing part. The position of the sealing element is also specified in this way, since it cannot release itself from the fillet on its own.

In the context of another embodiment of the invention, it can be provided that an elastic sealing element engages in a groove-shape depression of the fixing part and is preferably firmly clamped therein. This can be the same groove in which one or more anchoring parts, for example, one or more screws or rivets, engage and are anchored. The sealing element is then merely recessed or interrupted at the respective positions of the anchoring parts. Such a recess can, for example, be in the shape of a hole and be created, preferably manually, with the aid of a simple tool, for example, a hole punch or a knife. If an anchoring part is used that has a formed-on tip at the end directed toward the bottom of the groove, a recess of this kind is no longer necessary. In such cases, the rubber material of the seal can instead be bored through and/or supplanted by screwing in a screw or hammering or driving in a rivet. Under these circumstances, when the seal is to be replaced, a new screw or a new blind rivet can be inserted at any desired location in the groove; it is not necessary for such a screw or blind rivet to be inserted at the “old” position.

A fixing element—a flat such element, for example—can be firmly clamped to an outer face of an elastic sealing element. It then assumes the function of pressing the actual sealing element friction-lockingly against the fixing part. In this case, the sealing element itself need not be penetrated by the anchoring parts.

Another way of anchoring a fixing element is to firmly clamp the fixing part in a fillet. The desired position of the fixing element can be precisely specified and adhered to in this way.

According to the invention, an elastic sealing element and/or a fixing element can be composed of a plurality of mutually separate segments. These need not be joined together, but may optionally merely be fixed one after the other in a row, particularly by means of the anchoring parts according to the invention. Such segments of a fixing element can be, for example, a flat metal part (particularly of sheet metal), laser-cut strips, or punched tape.

The anchoring groove according to the invention can extend within a plane. In such cases it can follow a straight path or—as will be explained in more detail below—a curved, particularly a circular, path. The relative movement of the two parts to be sealed preferably takes place within this plane, i.e., the respective plane is not departed from during movement.

A special case arises with regard to sealing when the fixing part and the stop part are rotatable relative to each other about an axis of rotation. Rotational movements are not subject to any limitations and can therefore last almost indefinitely, so they present particular challenges in terms of obtaining a reliable seal.

The invention is also suitable for situations in which the axis of rotation of the mutually rotatable parts extends obliquely and/or perpendicularly to the plane of the groove. The inventive anchoring of a sealing element secures it both parallel to and transversely to its longitudinal or circumferential direction. For this reason, the orientation of the axis of rotation between the mutually rotatable parts is not a constraint for the sealing system according to the invention.

The invention recommends a sealing device of the generic kind, particularly when the fixing part and/or the stop part is/are each configured as a rotating part. In such cases, the sealing element can be configured as a self-contained biconnected element that runs along the annular gap. Even an endless sealing element of this kind is reliably anchored by the technique according to the invention.

A further design specification provides that the fixing part and/or the stop part is/are each configured as a ring, particularly having a circular shape, corresponding to a sealing element having an annular structure.

Finally, it corresponds to the teaching of the invention that one or more rows of rolling bodies are disposed in the gap between the stop part and the fixing part. The rolling bodies serve the purpose of keeping the width of the gap constant and/or of orienting the base planes of the two parts relative to one another, particularly aligning them in parallel.

### BRIEF DESCRIPTION OF THE DRAWINGS

Further features, details, advantages and effects based on the invention, will emerge from the following description of a preferred embodiment of the invention and by reference to the drawings, wherein

FIG. 1 is a section through a rotating bearing with a sealing element fixed according to the invention;

FIG. 2 illustrates another embodiment of the invention, also in section;

FIG. 3 is an illustration corresponding to FIG. 2 of a further-modified embodiment of the invention;

FIG. 4 is another modified embodiment of the invention, also in an illustration corresponding to FIG. 2; and

FIG. 5 is another modified embodiment of the invention in an illustration similar to FIG. 2.

### DESCRIPTION OF THE PREFERRED EMBODIMENTS

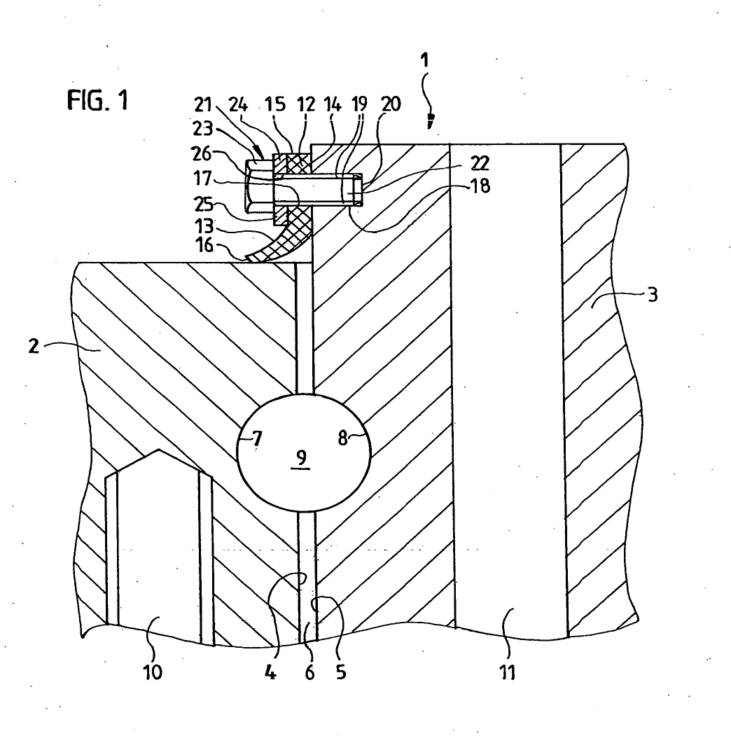

The rotary joint 1 depicted in FIG. 1 comprises an outer ring 2 (shown by way of example on the left in FIG. 1) and an inner ring 3 (shown on the right in FIG. 1) disposed concentrically inside the outer ring. Each of the two rings 2, 3 is provided with a generally rectangular cross section. The inner jacket surface 4 of the outer ring 2 is provided with a slightly larger diameter than the outer jacket surface 5 of the inner ring 3, thus resulting in a circumferential gap 6 between them. Provided in, particularly machined into, each of the facing jacket surfaces 4, 5 is a respective circumferential depression 7, 8 with a constant, preferably approximately circular-shaped, cross section. A row of rolling bodies, for example balls 9, can roll therein to permit relative rotation between the two rings 2, 3. The axis of rotation about which the rings 2, 3 rotate relative to one another is shifted far to the right of the drawing of FIG. 1, and is therefore not visible in the drawings. To make it possible to connect the rings 2, 3 to a respective adjacent construction (machine part, system part, vehicle part, frame or foundation), each ring 2, 3 is provided with a row of fixing bores 10, 11 extending parallel to the axis of rotation and distributed around the axis of rotation in a ring shape. These can be configured as through-bores or threaded blind bores. To make it easier to screw the two rings 2,3 to different system parts, the two rings 2, 3 are slightly offset from each other in the axial direction of the axis of rotation, with the result that, for example, at the upper (in FIG. 1) end face of the rotary joint 1, the one ring—in the example illustrated, inner ring 3—projects beyond the other ring—here, outer ring 2—thereby creating a kind of step configuration at the gap 6, i.e., a region where the outer jacket surface 5 of the inner ring 3 projects upward above the gap 6, unlike the inner jacket surface 4 of the outer ring 2.

The gap 6 is preferably filled with a lubricant, particularly grease. To keep the lubricant in the gap and protect it against the ingress of particles, the gap 6 is sealed at one, or preferably both, narrow sides. In the embodiment according to FIG. 1, this function is assumed by a flexible sealing element 12 in the form of a closed ring of flexible and elastic material, for example vulcanized, natural or synthetic rubber. The circumference of the sealing element 12 approximately corresponds to the length of the gap 6. Sealing element 12 preferably exhibits a ribbon shape with an elongated cross section, as can be seen in FIG. 1, comprising two flat sides 13, 14 joined together by two narrow sides 15, 16, which can also be configured as longitudinal edge(s). The cross section can, in particular, taper to one narrow side 16, so that a sealing lip is formed there. The sealing element 12 is also pierced by a plurality of perforations 17, particularly extending from one flat side 13 to the other flat side 14.

To fix the sealing element 12 to one of the two rings 2, 3—to inner ring 3 in the illustrated example—provided in the region of outer jacket surface 5 of inner ring 3 that projects upward above the gap 6 is a fully circumferential groove 18, preferably of rectangular cross section, whose flanks 19 extend in mutual parallelism approximately to the groove bottom 20. The width of the groove 18 approximately corresponds to the diameter of the perforations 17 in the sealing element 12. The distance from the lower groove flank 19 to the gap 6 is smaller than the distance from the perforations 17 of the sealing element 12 to its bottom narrow side 16 or sealing lip.

The sealing element 12 is fixed to the inner ring 3 by means of screws 21, particularly machine screws, which are inserted each through a respective perforation 17 of the sealing element 12 and are then rotated into the groove 18. The screws 21 are preferably provided with a self-tapping thread 22, i.e., as the screws 21 are rotated into the groove 18, each screw creates its own suitable internal thread segments in the groove 18, specifically in the groove flanks 19 locally, and these internal thread segments interact durably with the screw thread 22 and durably fix the screws 21 in the groove 18. It is advantageous for this purpose that the core of the screws 21 is equal to or less than the width of the groove, or the distance between the two groove flanks 19, whereas the outer circumference of the thread region 22 should be greater than the distance between the two groove flanks 19. In addition, the material of the screws 21 should be at least as hard as the material of the particular ring 3, and preferably harder. For this reason, it has proven beneficial to surface-harden the particular ring 3, at least locally in the vicinity of the depression 8, but not to through-harden it.

While this fixing causes a flat side 14 of the sealing element to be pressed against the surface of the particular ring 3, at least in the vicinity of the perforations 17, for example against the projecting region of a jacket surface, particularly the outer jacket surface 5 of inner ring 3, screw heads 23 engage over the outwardly disposed flat side 13 of the sealing element 12, i.e., the side facing away from the particular ring 3. To keep the screw heads 23 from slipping through the elastic material of the sealing element 12, a thrust ring 24, preferably consisting of a firm material such as, for example, metal, can be disposed between the outer flat side 13 of the sealing element 12 and the screw heads 23 gripping it; under some circumstances, the thrust ring 24 can also be composed of a plurality of segments, which need not be joined together. The thrust ring 24 preferably has the same circumference as the annular sealing element 12, and also resembles it by having a ribbon-shaped structure with an elongated cross section. The width of the flat sides 25 of the ribbon-shaped thrust ring 24 is, however, slightly narrower than the width of the flat sides 13, 14 of the ribbon-shaped sealing element 12. In addition, the thrust ring 24 comprises perforations 26, each of which preferably corresponds in dimensions and position to a respective perforation 17 in the sealing element 12, so that a respective screw 21 can be engaged through both together. Due to the thrust ring 24, the pressure force of the screw heads 23 is distributed over a large area, specifically over the entire flat side 25 of the thrust ring 24, thus reliably preventing damage to the sealing element 12 and keeping the screws 21 from slipping through their perforations 17. The screw heads 23 can be compassed at their periphery by a standard hexagon and/or provided at their free end face with a slot or cross slot. The thrust ring 24 may be unnecessary if screws 21 with a very large diameter screw head 23 are used.

In the context of the arrangement according to FIG. 1, in the illustrated variant, the inner ring 3 serves as a fixing part in the sense of the invention, whereas the outer ring 2 is used as a stop ring. It would also, of course, be possible instead to fix a sealing element to the outer ring 2 and have its sealing lip graze along the inner ring 3, if, for example, the outer ring 2 is raised relative to the inner ring 3 in the region of the underside of the rotary joint 1. In general, the issue of whether the inner ring or an outer ring serves as the fixing part is not crucial for the fixing of the sealing element within the scope of this application.

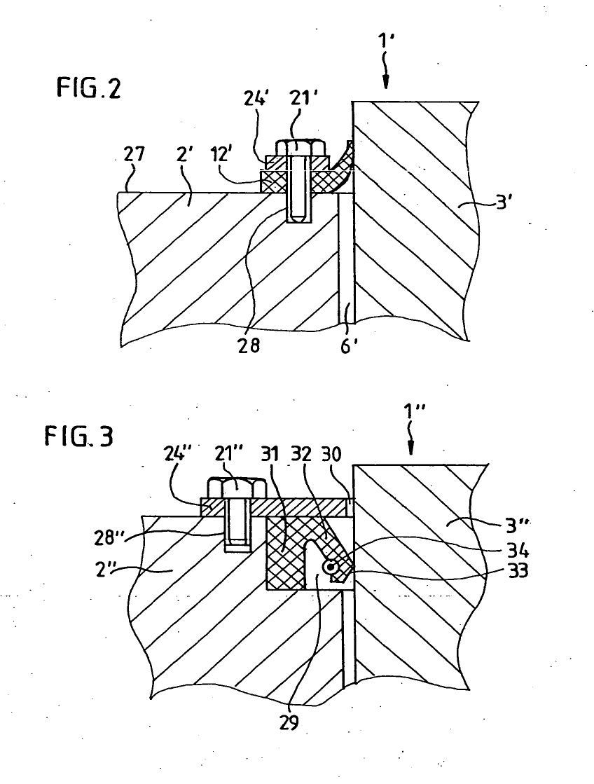

FIG. 2 shows an embodiment of the seal that has been modified with respect to the foregoing. The rotary bearing 1′ shown differs from the one previously described only in the manner of fixation of the annular sealing element 12′. Here, in contrast to the previously described embodiment, the latter element does not rest against the jacket surface of the respective end face of the raised ring which faces the gap of the ring, but rather, against the end face 27 of the ring that is offset in the axial direction, i.e., in the case of FIG. 2, the end face 27 of inner ring 2′ shown on the left. There, a fully circumferential groove 28 is present, into which the screws 21′ are turned as in the previously described embodiment. The relative dimensions of the groove 28 and the screws 21′ are the same as in the embodiment according to FIG. 1. Here again, a thrust ring 24′ can be provided, whose cross section can correspond to that of the thrust ring 24 from FIG. 1. In all cases, the axis of curvature about which both the sealing ring 12, 12′ and the thrust ring 24, 24′ are curved corresponds to the axis of rotation of the rotary bearing 1, 1′. It should, of course, be kept in mind that in the case of the thrust ring 24 according to FIG. 1, the axis of curvature is oriented parallel to the particular ring cross section, whereas in the case of the thrust ring 24′ of FIG. 2, it is oriented approximately perpendicular to the ring cross sections. Although this has virtually no significance for the flexible sealing element 12, 12′, it should be noted in regard to the relatively firm or rigid thrust ring 24, 24′, that the latter can be bent from a straight ribbon in the case illustrated in FIG. 1 and then welded, or soldered, to form a ring 24; ring 24′, on the other hand, is to be punched into a ring shape from sheet metal.

The arrangement of a rotary bearing 1″ according to FIG. 3 represents a modification of the arrangement from FIG. 2. The annular sealing element 12″ is received in a fillet 29, which is machined into the region of the edge between the set-back end face 27″ and jacket surface 4″ of the particular ring—here, outer ring 2″—which faces the gap 6″, and which can have an approximately rectangular to nearly square cross section. The thrust ring 24″ has a greater width and extends from groove 28″, located to one side of the fillet 29, all the way across the fillet 29 and covers it, except for a narrow gap 30 relative to the jacket surface 5″ of the facing ring—here, inner ring 3″.

In this embodiment 1″, the annular sealing element 12″ is provided with a cross section with two legs 31, 32 that form an acute angle with each other. One leg 32 bears, on its outer side facing away from the other leg 31, a preferably obtuse-angled sealing lip 33, which runs along the jacket surface 5″ of the non-filleted ring 3″. The sealing lip 33 can be pressed against the jacket surface 5″ serving as the stop surface by a fully circumferential tension wire 34 that extends tautly around leg 32 on the opposite side of the leg from the sealing lip 33. The other leg 31, in contrast, serves primarily to positionally fix the sealing element inside the fillet 29. To this end, the cross-sectional length of this leg, measured parallel to the axis, approximately corresponds to the height of the fillet 29 measured parallel to the axis. The leg 31 can also be embodied as more massive than the leg 32 bearing the sealing lip 33.

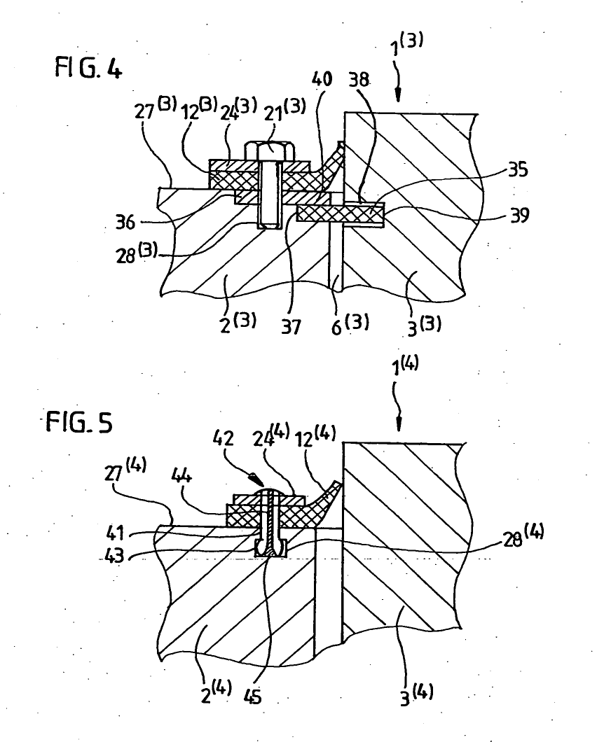

Embodiment 1⁽³⁾ according to FIG. 4 can be seen as a combination of the sealing arrangements according to FIGS. 2 and 3. It includes two sealing elements 12⁽³⁾, 35, disposed one above the other in the axial direction, both of them fixed to the same ring—in the present example, inner ring 2⁽³⁾—and both grazing along the other ring—in the present example, outer ring 3⁽³⁾. Upper sealing element 12⁽³⁾ here is identical to sealing element 12 from FIG. 2; the thrust ring 24⁽³⁾ and the screws 21⁽³⁾ also correspond to the arrangement of FIG. 2. As in that case, here again the groove 28⁽³⁾ is machined into the end face 27⁽³⁾ of the ring 2⁽³⁾ that is set back in the axial direction.

Similarly to the embodiment according to FIG. 3, a filleted region 29⁽³⁾ is also present here in the region between the set-back end face 27⁽³⁾ and the adjacent jacket face 4⁽³⁾. In this variant, however, the fillet is not provided with a rectangular cross section, but rather a stepped cross section resembling a staircase with two steps 36, 37, the top step 36 being farther away from the gap 6⁽³⁾ than the bottom step 37. The groove 28⁽³⁾ in this embodiment is not located next to the fillet 29⁽³⁾, but passes through the top step 36 of the fillet 29⁽³⁾.

A sealing ring 35 with an elongated, optionally rectangular, cross section rests on the bottom step 37 of the fillet 29⁽³⁾. Since this sealing ring 35 is mounted with its cross section horizontal, the sealing ring 35 can be characterized as an annular disk. This arrangement can be devised such that that jacket surface 5⁽³⁾ of the opposite ring 3⁽³⁾, which serves as the stop face, has a fully circumferential groove 38, for example, of rectangular cross section, at the level of this sealing ring 35. The region of the sealing ring 35 near its free longitudinal edge or narrow side 39 can engage in this groove 38, thus creating not only friction-locking contact, but also, effectively, form-locking contact.

The sealing ring 35, whose height corresponds generally to the height of the bottom step 37, is covered by a spacer ring 40 placed on the top step 36 and is thereby held in position. The screws 21⁽³⁾ pass through the spacer ring 40, along with the upper sealing element 12⁽³⁾ and the thrust ring 24⁽³⁾ disposed thereon, and screw their thread into the groove 28⁽³⁾. Under some circumstances, the spacer ring 40 may be composed of a plurality of segments that need not be joined together.

Since the lower sealing ring 35 is fixed form-lockingly in the fully circumferential, groove-shaped depression 38, this seal can durably withstand even relatively large pressure differences between the gap 6⁽³⁾ and the external environment.

The arrangement according to FIG. 5 represents a modification of the arrangement according to FIG. 2. The arrangement of the stepped rings 2⁽⁴⁾, 3⁽⁴⁾ and the gap 6⁽⁴⁾ between them, together with the sealing element 12⁽⁴⁾ and the thrust ring 24⁽⁴⁾, is completely identical to the arrangement from FIG. 2. The position of the fully circumferential groove 28⁽⁴⁾ also corresponds to the arrangement according to FIG. 2. However, the flanks 41 of the groove 28⁽⁴⁾ are not straight in this case, but broaden, particularly in stepwise fashion, to the groove bottom 20⁽⁴⁾, thus forming an undercut.

The sealing element 12⁽⁴⁾, together with the thrust ring 24⁽⁴⁾, is fixed in this groove 28⁽⁴⁾ not with screws, but with blind rivets 42. Each blind rivet 42 comprises a sleeve 43 and a pin 44. At its end inserted in the groove 28⁽⁴⁾, the pin 44 is provided with a thickening 45. Once the sleeve 43 has been mated onto and positioned on the pin 44, the thickening can be pulled into the sleeve 43 and widens it, causing it to expand into the undercut region of the groove 28⁽⁴⁾ and thus be anchored form-lockingly in the groove 28⁽⁴⁾. The portion of the pin 44 that is pulled out of the sleeve 43 in the process ultimately breaks off, and the free end of the sleeve 43 is hammered flat in the customary manner and thus grips the sealing element 12⁽⁴⁾ and the thrust ring 24⁽⁴⁾ resting thereon.

Such blind rivets 42 can be used in place of the above-described screws 21 in all of the embodiments described hereinabove, as well as in other applications of the invention.

It should be noted that the invention can naturally be used not just for rotary bearings, but also for other parts that are moved relative to one another, regardless of whether they are rotated or moved linearly with respect to one another.

1. A device for sealing a gap (6) between at least two fixing parts (2, 3) that are moveable relative to one another, the device comprising one of the fixing parts (2, 3) to which at least one elastic sealing element (12, 35) is fixed in a region of one of a longitudinal edge (15), and a stop part (3; 2) along which another edge (16, 39) of at least one elastic sealing element (12, 35) extends, wherein said fixing part (2; 3) is provided with, running along the gap (6), at least one groove (18; 28) in which engage one or more anchoring parts (21; 42) that engage(s) through or around said sealing element (12) and/or at least one retaining element (24) that retains same.

2. The device as in claim 1, wherein the extent of a portion of an anchoring part (21; 42) engaging in said groove (18; 28) is, in a longitudinal direction of said groove (18; 28), equal to or less than twice a maximum width of said groove (18; 28), preferably equal to or less than one and a half times a maximum width of said groove (18; 28).

3. The device as in claim 1, wherein the extent of a core of a portion of an anchoring part (21; 42) engaging in said groove (18; 28) generally corresponds, in the longitudinal direction of said groove (18; 28), to a groove width.

4. The device as in claim 1, wherein an anchoring part comprises a screw (21), preferably a machine screw, particularly a machine screw with a self-tapping thread (22).

5. The device in accordance with claim 1, wherein an anchoring part comprises a rivet, particularly a blind rivet (42), whose inner, broadened end is disposed in an undercut region of said groove (18; 28) that is broadened relative to a groove aperture.

6. The device in accordance with claim 1, wherein an anchoring part (42) comprises a sleeve (43) adapted to be pushed or slid onto a core or pin (44).

7. The device as in claim 6, wherein the core or pin (44) exhibits a broadening or thickening (45) in the region of a groove bottom, in order to expand the pushed-on sleeve (43) in the region of the groove bottom.

8. The device in accordance with claim 4, wherein a portion of an anchoring part (21; 42) provided to engage in said groove (18; 28) is provided with a rotationally symmetrical cross section, apart from the thread (22) disposed thereon.

9. The device in accordance with claim 1, wherein a portion of an anchoring part for engagement in said groove (18; 28) exhibits an elongated cross section that allows the anchoring part to be inserted when rotated in the longitudinal direction of said groove (18; 28) and anchored against an undercut of said groove (18; 28) when rotated transversely to the longitudinal direction of said groove (18; 28).

10. The device in accordance with claim 1, wherein an elastic sealing element (12, 35) is clamped to a surface (4; 5; 27) of said fixing part (2; 3).

11. The device in accordance with claim 1, wherein an elastic sealing element (12, 35) is clamped in a fillet (29; 36, 37) of said fixing part (2; 3).

12. The device in accordance with claim 11, wherein said elastic sealing element (12, 35) engages in a groove-shaped depression (18; 28) of said fixing part (2; 3) and is clamped therein.

13. The device in accordance with claim 10, wherein a fixing element (24) is firmly clamped on an outer side (13) of the elastic sealing element (12).

14. The device in accordance with claim 1, wherein a fixing element (40) is clamped in a fillet (29) of said fixing part (2; 3).

15. The device in accordance with claim 1, wherein said elastic sealing element (12, 35) and/or a fixing element (24; 40) comprises a plurality of mutually separate segments.

16. The device in accordance with claim 1, wherein said groove (18; 28) extends within a plane.

17. The device in accordance with claim 1, wherein said fixing part (2; 3) and said stop part (3; 2) are rotatable relative to each other about an axis of rotation.

18. The device in accordance with claim 17, wherein said axis of rotation extends perpendicularly and/or obliquely to a plane of said groove (18; 28).

19. The device in accordance with claim 17, wherein said fixing part (2; 3) and/or said stop part (3; 2) each comprise rotating parts.

20. The device in accordance with claim 17, wherein said fixing part (2; 3) and/or said stop part (3; 2) is/are each configured as a ring.

21. The device in accordance with claim 1, wherein one or more rows of rolling bodies (9) are disposed in the gap (6) between said stop part and said fixing part (2, 3).
